(19) United States
(12) Patent Application Publication
(10) Pub. No.: US 2025/0276906 A1
(43) Pub. Date: Sep. 4, 2025

(54) PROCESS AND PLANT FOR PRODUCING AMMONIA

(71) Applicant: GASCONTEC GMBH, BAD HOMBURG V. D. HOEHE (DE)

(72) Inventors: WOLF BALTHASAR, RATINGEN (DE); WOLFGANG LAUER, SCHWALMSTADT 11 (DE); DORIT RAPPOLD, FRANKFURT (DE); ULRICH WAGNER, BERNBURG, OT BIENDORF (DE)

(73) Assignee: GASCONTEC GMBH, BAD HOMBURG V. D. HOEHE (DE)

(21) Appl. No.: 18/859,556

(22) PCT Filed: Apr. 25, 2023
(86) PCT No.: PCT/EP2023/060797

§ 371 Date: Oct. 24, 2024

(30) Foreign Application Priority Data
Apr. 26, 2022 (EP) 22170094.1

(51) Int. Cl. C01C 1/04; B01D 53/04; B01D 53/047; B01D 53/14; B01D 53/22; C01B 3/02; C01B 3/12; C01B 3/36; C01B 3/56

(52) U.S. Cl. CPC C01C 1/04; B01D 53/0462; B01D 53/047; B01D 53/1406; B01D 53/1475; B01D 53/1493; B01D 53/22; C01B 3/025; C01B 3/12; C01B 3/36; C01B 3/56; B01D 2252/2021; B01D 2256/16; B01D 2257/504; C01B 2203/0244; C01B 2203/0283; C01B 2203/042; C01B 2203/0475; C01B 2203/068; C01B 2203/0838; C01B 2203/1241

(57) ABSTRACT

A method for producing ammonia. The method includes providing an oxygen flow from an oxygen producing assembly, providing a carbon-containing energy carrier flow, feeding the carbon-containing energy carrier flow and the oxygen flow to a synthesis gas reactor assembly to obtain a synthesis gas flow which includes hydrogen and carbon oxides, feeding at least a part of the synthesis gas flow to an adsorption device which separates the synthesis gas flow into a hydrogen flow which includes hydrogen and into a purge flow which includes carbon oxides, providing a nitrogen flow, feeding at least a part of the hydrogen flow and the nitrogen flow to an ammonia reactor assembly which converts the part of the hydrogen flow and the nitrogen flow into ammonia, and feeding at least some of the carbon oxides in the purge flow to the synthesis gas reactor assembly.

The invention relates to a method for producing ammonia having the features of the preamble of claim 1 and a plant for producing ammonia having the features of the preamble of claim 16.

Ammonia is a substance that is becoming increasingly important as a medium for transporting hydrogen. This is mainly because it can be transported more easily and above all more efficiently in energetic terms than pure hydrogen and can also be very easily separated back into the components, nitrogen and hydrogen.

In this context, there is increased interest in producing ammonia in a way that has a very small CO2 footprint. In the case of a “low-low carbon footprint”, one also speaks of “blue” hydrogen and “blue” ammonia.

The production of ammonia is based on hydrogen and nitrogen as starting materials, wherein the hydrogen in particular is regularly provided by synthesis gas, which synthesis gas is typically obtained from a carbon-containing energy carrier flow such as natural gas. The main processes leading to the release of carbon dioxide are on the one hand the decomposition of ambient air to obtain nitrogen. This decomposition requires a certain amount of energy, which in turn might be the reason for CO2 emissions into the atmosphere.

On the other hand, the production of the synthesis gas also requires energy; especially when a steam reformer is used for this purpose, up to 30% of the natural gas used is required to underfire it. The CO2 contained in the flue gas in such a case is released into the atmosphere. CO2 that otherwise arises in the process can be separated and used without being released into the atmosphere, by scrubbing.

A reduction in the amount of CO2 emitted in the flue gas, corresponding to around 10% of the natural gas used, can be achieved by using only autothermal reforming instead of steam reforming to generate the synthesis gas. Such an approach is disclosed in EP 2 401 280 B1, for example, on which the present invention is based as the closest prior art. With autothermal reforming, no external supply of heat is needed to generate the synthesis gas. Furthermore, the air separation, which is required anyway, can also provide the nitrogen for the ammonia synthesis directly.

However, this already considerable reduction in the CO2 footprint is not yet sufficient for “blue” hydrogen or “blue” ammonia. Further options for reducing the CO2 footprint are, firstly, to provide smoke scrubbing, which however entails substantial investment and a further increase in energy demand. Secondly, it would also be possible to operate heat exchangers electrically that would otherwise be operated using natural gas. But then a significant amount of CO2-neutral electricity must be provided for this, and the problem remains of what to do with discharged purge gas, which is normally burned to run the heat exchangers. Such a discharge is necessary to avoid the otherwise increasing concentration of inert substances in the circuit.

Based on the prior art, the object of the invention is therefore to provide an improved approach for the production of ammonia which has a very low CO2 footprint.

With regard to a process for producing ammonia according to the preamble of claim 1, this task is solved by the features of the characterizing part of claim 1. With regard to a plant for the synthesis of ammonia according to the preamble of claim 16, this task is solved by the features of the characterizing part of claim 16.

The invention is based on the realization that in order to substantially avoid CO2 emissions during ammonia synthesis, the purge flow that arises when separating the hydrogen in the synthesis gas may be returned to the synthesis gas reactor. In the synthesis gas reactor, methane contained in this purge flow may be converted into synthesis gas, so that methane does not accumulate in the circuit. Apparatuses in the circuit such as a CO2 scrubber may remove CO2 from the circuit, while carbon monoxide may be converted into a carbon dioxide for washing out by means of a shift device, for example. The heat exchangers may then be underfired mainly by hydrogen, the combustion of which does not produce any CO2. To avoid the accumulation of inert substances, a small part of the purge flow can continue to be diverted for underfiring, wherein the corresponding amount may be selected such that the criteria for “blue” hydrogen or “blue” ammonia are met.

Subordinate claim 3 describes a variant that does not require an additional separating device other than the apparatus for separating the hydrogen for ammonia synthesis, and is therefore particularly easy to implement in terms of construction.

On the other hand, a variant with a membrane device or a PSA for separating hydrogen from the purge flow of said device for separating hydrogen is described in subordinate claims 4 to 8. These variants allow a particularly substantial reduction in CO2 emissions.

Effective recovery of CO2 from the process without releasing it into the atmosphere is made possible by the carbon dioxide scrubbing described in subordinate claims 10 to 13. The CO2 washed out in this way can be injected or otherwise utilized without being released into the atmosphere.

Further details, features, configurations, objectives and advantages of the present invention are explained below with reference to the drawing, which shows embodiments of only exemplary nature. In the drawing

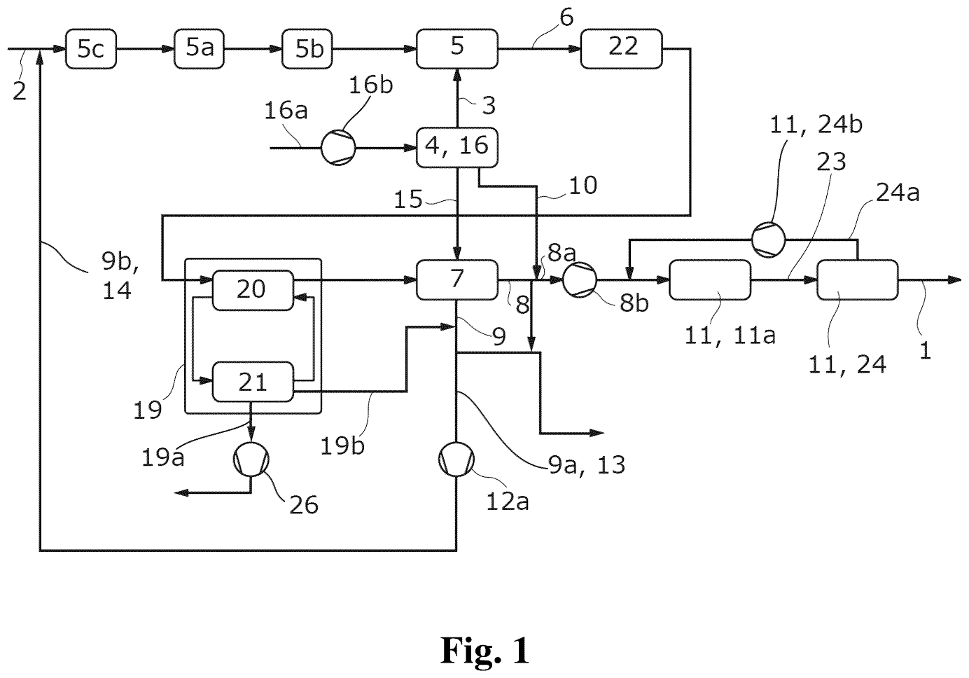

FIG. 1 is a schematic representation of the flow diagram of a suggested plant for carrying out the suggested process according to a first exemplary embodiment,

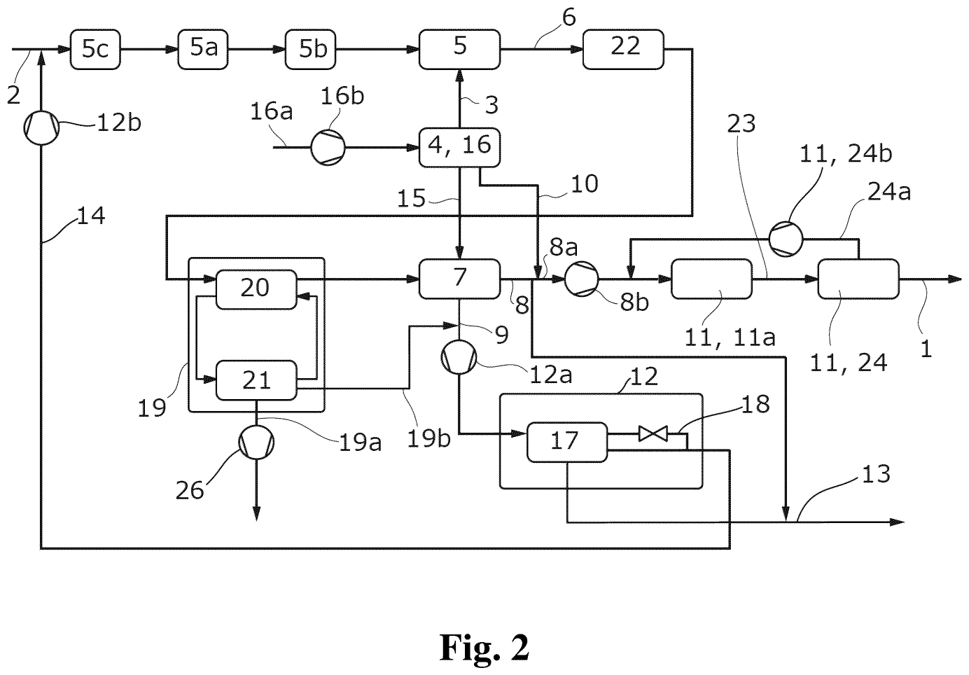

FIG. 2 is a schematic representation of the flow diagram of a suggested plant for carrying out the suggested process according to a second exemplary embodiment, and

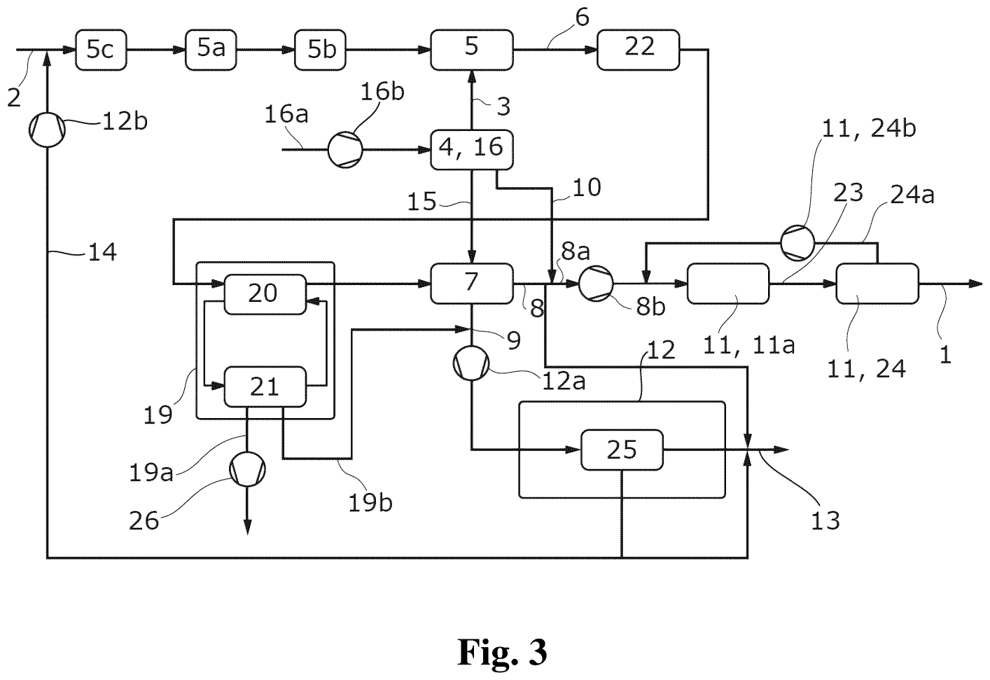

FIG. 3 is a schematic representation of the flow diagram of a suggested plant for carrying out the suggested process according to a third exemplary embodiment.

The suggested process is used to produce ammonia 1, this production being carried out by synthesis in a manner known per se from the prior art. Specifically, a first exemplary embodiment of the suggested process is performed by the suggested plant shown in FIG. 1 for producing ammonia 1 and initially also described with reference to the plant of FIG. 1.

Regarding the further exemplary embodiments of the suggested process and the suggested plant according to FIGS. 2 and 3, the differences from the exemplary embodiment of FIG. 1 are described. Unless otherwise stated, the exemplary embodiments in FIGS. 2 and 3 correspond to the exemplary embodiment of FIG. 1.

According to the representation of FIG. 1, the suggested plant has an oxygen producing assembly 4 for providing an oxygen flow 3, a synthesis gas reactor assembly 5 for obtaining a synthesis gas flow 6, which contains hydrogen and carbon oxides, from a carbon-containing energy carrier flow 2 and the oxygen flow 3, and an adsorption device 7 for separating at least a part of the synthesis gas flow 6 into a hydrogen flow 8 containing hydrogen and a purge flow 9 containing carbon oxides. The suggested plant also has an ammonia reactor assembly 11 for converting at least a part of the hydrogen flow 8 and a nitrogen flow 10 into ammonia 1. The carbon oxides refer to carbon monoxide and carbon dioxide.

The suggested plant is characterized in that at least some of the carbon oxides in the purge flow 9 are fed to the synthesis gas reactor assembly 5. In principle, this feed may be carried out directly, so that a part of the purge flow 9 is thus branched off and fed to the synthesis gas reactor assembly 5. However, as will be described in greater detail below, it may also be the case that the partial supply of carbon oxides takes place indirectly in the purge flow 9 to the synthesis gas reactor assembly 5.

Further, the suggested plant is set up in particular to perform the suggested process.

Correspondingly manner to the suggested plant, in the suggested process the carbon-containing energy carrier flow 2 and the oxygen flow 3 are fed from the oxygen producing assembly 4 to the synthesis gas reactor assembly 5. The carbon-containing energy carrier flow 2 may be a natural gas flow containing methane, water, nitrogen, hydrogen sulfide, ethane, propane, and possibly smaller proportions of butane. It may also be a flow of associated petroleum gas. It is preferred that the molar proportion of nitrogen in the natural gas flow is between 0.1% and 1%.

The oxygen flow 3 comprises oxygen, preferably in a molar proportion of at least 80%, in particular at least 98%. The energy carrier flow 2 may also be pretreated before it is fed to the synthesis gas reactor assembly 5, for example by feeding it to a pre-reformer 5a—also shown in FIG. 1—, to a preheater 5b for heating the energy carrier flow, to a natural gas compressor 5c for increasing the pressure of the energy carrier flow 2, preferably to at least 50 bar, or to a desulfurization step—not shown here. These apparatuses are preferably also included in the suggested plant.

In the suggested process, the synthesis gas reactor assembly 5 is configured to obtain the synthesis gas flow 6 with hydrogen and carbon oxides. In this context, the hydrocarbons are converted into hydrogen and carbon oxides—that is to say, carbon monoxide and carbon dioxide—in the synthesis gas reactor assembly 5, in a manner known per se from the prior art.

Moreover, in the suggested process and in accordance with the representation of FIG. 1, at least some of the synthesis gas flow 6 is fed to the adsorption device 7 in order to separate the synthesis gas flow 6 into the hydrogen flow 8 containing hydrogen and the purge flow 9 containing carbon oxides. Besides this, the purge flow 9 may also contain methane. The methane in the purge flow 9 originates from the “methane slip” of the synthesis gas reactor assembly 5. This is the fraction of methane in the energy carrier flow 2 which is not converted into hydrogen and carbon oxides in the synthesis gas reactor assembly 5 but remains as methane and subsequently becomes part of the synthesis gas flow 6. Further inert substances may also be contained in the purge flow 9. The advantage of using an adsorption device and in particular when using a pressure swing adsorption device—described in greater detail below—is that, unlike liquid nitrogen scrubbing, it can still be used even if the flow fed to it has a higher proportion of CO2.

Before it is fed to the adsorption device 7, the synthesis gas flow 6 may be treated in various ways, as will be described in greater detail below. It may also be the case that, apart from a flushing flow 15 that may be supplied and is described in greater detail below, the purge flow 9 substantially consists of the components of the synthesis gas flow 6 minus the hydrogen flow 8.

In the suggested process, at least a part of the hydrogen flow 8 as well as a nitrogen flow 10, is fed to the ammonia reactor assembly 11, where it is converted into ammonia 1. Regarding the nitrogen flow 10, this preferably consists substantially of nitrogen. It is further preferred that, as shown in the figures, at least a part of the hydrogen flow 8 is combined with the nitrogen flow 10 to form a feed flow 8a, and this feed flow 8a is fed to a feed compressor 8b for compressing the feed flow 8a before the hydrogen flow 8 and the nitrogen flow 10 combined with it is fed to the ammonia reactor assembly 11 as feed flow 8a. The suggested plant preferably comprises the feed compressor 8b.

The suggested process is characterized in that at least a part of the carbon oxides in the purge flow 9 is fed to the synthesis gas reactor assembly 5. Since these carbon oxides have already passed through the synthesis gas reactor assembly 5 at least once, this feed is actually a return to the synthesis gas reactor assembly 5.

It is preferred that a recovery flow 13 and an exhaust gas flow 14 are obtained from the purge flow 9 and that at least a part of the exhaust gas flow 14 is fed to the synthesis gas reactor assembly 5. The recovery flow 13 is preferably a hydrogen-containing recovery flow 13. Also preferably, the exhaust gas flow 14 contains carbon oxides. It is preferred here that—as shown in FIGS. 1 to 3—the exhaust gas flow 14 is fed into the energy carrier flow 2 upstream of the natural gas compressor 5c in terms of the process. However, it may also be the case that the exhaust gas flow 14 is fed into the energy carrier flow 2 downstream of the natural gas compressor 5c in terms of the process, and in particular is fed in between the natural gas compressor 5c and the pre-reformer 5a in terms of the process. It may also be the case that the pressure in the exhaust gas flow 14 is increased by an exhaust gas flow compressor 12b, as shown in FIGS. 2 and 3. This exhaust gas flow compressor 12b is preferably included in the plant.

In principle, the recovery flow 13 and the exhaust gas flow 14 may also have a substantially identical composition.

In the event that the exhaust gas flow 14 contains carbon oxides, the exhaust gas flow 14 may contain carbon oxides in any proportion, as long as the exhaust gas flow 14 contains carbon oxides at all. Likewise, if the recovery flow 13 is a hydrogen-containing recovery flow 13, in principle it may contain hydrogen in any proportion, also as long as the recovery flow 13 contains hydrogen at all.

It is further preferred that the recovery flow 13 is used to underfire a heat exchanger. This heat exchanger may in particular be a heat exchanger of the preheater 5b for heating the energy carrier flow 2. It may also be the case that additional heat exchangers are underfired by the recovery flow 13. Likewise, it may be that the recovery flow 13 serves not only to underfire a heat exchanger, but also to provide superheated steam for the operation of one or more compressors of the plant. It is therefore preferred that the second purge partial flow 9b and/or the recovery flow 13 is/are used to enable steam superheating to operate compressors in the plant. In particular, the recovery flow 13 may be used for steam superheating to operate an air compressor 16b of the air separation unit 16, natural gas compressor 5c, the feed compressor 8b, the exhaust gas flow compressor 12b, the residual gas compressor 24b described below and/or the recovery compressor 12a also described below or the CO2 compressor 26 also described below.

The described recovery of the recovery flow 13 and the exhaust gas flow 14 may basically be carried out in any way. A preferred variant according to the exemplary embodiment of FIG. 1 provides that the purge flow 9 is divided into at least two partial purge flows 9a, 9b, that a first partial purge flow 9a forms the recovery flow 13, and that a second partial purge flow 9b forms the exhaust gas flow 14. It may be seen that the carbon dioxide of the first partial purge flow 9a is released into the atmosphere, whereas the carbon dioxide of the second partial purge flow 9b remains in the process. Consequently, the amount of CO2 emitted into the atmosphere can be determined by adjusting the distribution ratio between the first partial purge flow 9a and the second partial purge flow 9b. It is preferred that the recovery flow 13 and the exhaust gas flow 14 have a respective amount and a respective composition according to which at least 95%, and in particular at least 98% of the carbon supplied with the energy carrier flow 2, preferably with the natural gas flow, is sequestered or mineralized. The effect that is common to both sequestration and mineralization is that the carbon dioxide concerned is not released into the atmosphere.

Unlike the first exemplary embodiment of FIG. 1, the respective plants of the second exemplary embodiment shown in FIG. 2 and the third exemplary embodiment in FIG. 3 each have a recovery assembly 12. In particular in this case, it is preferred that the purge flow 9 is fed to the recovery assembly 12, which recovery assembly 12 extracts the recovery flow 13 and the exhaust gas flow 14 from the purge flow 9. Consequently, what takes place is not a mere splitting of the purge flow 9, but rather the recovery assembly 12 performs a separation according to substances. Accordingly, it is preferred that the recovery flow 13 has a higher molar hydrogen content than the exhaust gas flow 14. It may also be the case that the exhaust gas flow 14 has a higher molar proportion of carbon oxides than the recovery flow 13.

The recovery of such flows, each with different compositions may be carried out in various ways. According to the exemplary embodiment of FIG. 2, it is preferably provided that the recovery assembly 12 has a membrane device 17 for separating hydrogen out of the purge flow 9. In particular, it may be that the membrane device 17 separates the recovery flow 13 out of the purge flow 9, whereby the exhaust gas flow 14 remains. In this case, it may further be that a part of the exhaust gas flow 14 is used as a membrane flushing flow 18 for flushing out the recovery flow 13.

The exemplary embodiment of FIG. 3 provides a further option for obtaining flows with different compositions from the purge flow 9. In particular, it is preferred that the recovery assembly 12 includes a recovery adsorption device 25 for separating hydrogen out of the purge flow 9. The recovery adsorption device 25 preferably separates the recovery flow 13 out of the purge flow 9, leaving the exhaust gas flow 14. The recovery flow 13 preferably consists substantially of hydrogen. In this variant, a part of the exhaust gas flow 14 is preferably also used to underfire the one or more heat exchangers. In particular—as shown in FIG. 3—a part of the exhaust gas flow 14 may be branched off to the recovery flow 13. In this way, the accumulation of nitrogen in the synthesis gas circuit is avoided.

With regard to the recovery adsorption device 25, several variants are conceivable. In particular, it may be that the recovery adsorption device 25 is configured for pressure swing adsorption and/or for temperature swing adsorption. The exemplary embodiment of FIG. 3 specifically shows a recovery adsorption device 25 for pressure swing adsorption, that is to say a PSA.

According to the exemplary embodiments of FIGS. 2 and 3, it is preferred that the recovery assembly 12 includes a recovery compressor 12a, which increases the pressure of the purge flow 9. The pressure of the purge flow 9 is preferably increased before the purge flow 9 is fed to the recovery adsorption device 25 or before the purge flow 9 is fed to the membrane device 17.

It may be that the recovery flow 13 contains insufficient hydrogen overall to underfire the heat exchangers. In this case, it is preferred that at least a part of the hydrogen flow 8 is used to underfire a heat exchanger or several heat exchangers. In order to achieve this—as shown in the figures—at least a part of the hydrogen flow 8 may be supplied to the recovery flow 13. It is preferred that a part of the hydrogen flow 8 for the supply to the recovery flow 13 is branched off upstream of the supply to the nitrogen flow 10 in terms of the process. Underfiring with hydrogen produces water instead of carbon dioxide. In this way, enough energy can be provided to underfire the heat exchangers without releasing further CO2 into the environment.

It is preferred that the synthesis gas flow 6 is fed to a carbon dioxide scrubber 19 for washing at least part of the carbon dioxide out of the synthesis gas flow 6. This carbon dioxide scrubbing step 19, which can also be referred to as a carbon dioxide scrubber, is preferably part of the suggested plant. In principle, at least some of the carbon dioxide can be washed out of the synthesis gas flow 6 in any way in this carbon dioxide scrubber 19. However, it is preferred that in the carbon dioxide scrubber 19 the carbon dioxide is washed out with a scrubbing medium comprising methanol. It is also preferred that the carbon dioxide is washed out of the synthesis gas flow 6 by the carbon dioxide scrubber 19 substantially completely. The carbon dioxide scrubber 19 preferably discharges a carbon dioxide containing flow 19a and a hydrogen-containing flow 19b. This is described in greater detail below.

Here it is also preferred that the synthesis gas flow 6 is fed to an absorption stage 20 of the carbon dioxide scrubber 19 to absorb the carbon dioxide into the scrubbing medium and that the scrubbing medium is circulated in a loop in the absorption stage 20 and a regeneration stage 21 of the carbon dioxide scrubber 19 to release carbon dioxide from the scrubbing medium. The mode of operation of such a scrubbing apparatus is known from the prior art.

It is particularly advantageous if the scrubbing medium comprises cold methanol and is thus transported in a “cold methanol circuit”, which is also referred to as a “cold methanol loop”. Accordingly, it is preferred that a temperature of the scrubbing medium in the carbon dioxide scrubber 19 is constantly below −10° C. In the regeneration stage 21, even lower temperatures are reached regularly, for example between −60° C. and −80° C. It may also be that the temperature of the scrubbing medium in the carbon dioxide scrubber 19 is consistently below −20° C. or even below −30° C. The corresponding pressure conditions of the scrubbing medium are described below.

It is preferably provided here that the carbon dioxide is released from the scrubbing medium in the regeneration stage 21 essentially by reducing the pressure in the scrubbing medium. In this way, the carbon dioxide-containing flow 19a may be obtained. In particular, it is preferred that the carbon dioxide is released from the scrubbing medium in the regeneration stage 21 without heating. Accordingly, there is no need for heating for the purpose of regeneration, for which heating usually a complex separate plant part—referred to as a hot regenerator—must be provided. This in turn reduces the expenditure on equipment and the energy requirement for the carbon dioxide scrubber 19, which is characteristic of the cold methanol loop approach. After the carbon dioxide has been released from the scrubbing medium without heating, on the other hand, it is entirely possible for the carbon dioxide to be heated, for example to a temperature range between 0° C. and 20° C. by heat exchange with hot synthesis gas that is to be cooled.

Advantageous for the implementation of such regeneration practically exclusively by pressure relief are minor requirements regarding the target residual content—molar proportion—of carbon dioxide in the synthesis gas flow 6 that is fed to the adsorption device 7, said molar proportion preferably being in the range between 0.2% and 3%, more preferably between 0.5% and 1%. In the exemplary embodiments shown, the carbon dioxide scrubber 19 is followed by the adsorption device 7 for pressure swing adsorption and thus for the removal of carbon oxides, methane and other inert substances, so that the residual carbon dioxide remaining in the synthesis gas flow 6 after the carbon dioxide scrubber 19 is effectively removed there.

Such a regeneration substantially through pressure relief can be performed particularly effectively when the synthesis gas flow 6 is passed through the carbon dioxide scrubber 19 at the highest possible pressure. Moreover, in this context it is preferred that the scrubbing medium is pumped to a higher pressure during the circulation supply from the regeneration stage 21 to the absorption stage 20. This corresponds to the opposite process to the pressure relief process described above.

The drastic cooling of the scrubbing medium that occurs when the pressure is relieved is a desired and characterizing effect of the cold methanol loop. It means that the regenerated and recycled scrubbing medium can absorb the carbon dioxide extremely efficiently again, so that the overall size of the carbon dioxide scrubber 19 may be very compact and the amount of scrubbing medium required can be very small.

When carbon dioxide is washed out, other components of the scrubbed gas flow, such as hydrogen, are also washed out. However, during the pressure relief of the scrubbing medium described above, the various washed out gases are mainly released at different pressure relief levels. This makes it possible for the carbon dioxide scrubber 19—and specifically the regeneration stage 21—to release the carbon dioxide-containing flow 19a and a hydrogen-containing flow 19b. Consequently, the carbon dioxide scrubber 19 can remove the hydrogen-containing flow 19b by first relieving the pressure in the scrubbing medium in the regeneration stage 21 and discharge the carbon dioxide-containing flow 19a with a second relief of pressure in the scrubbing medium in the regeneration stage 21. In terms of the compositions, the carbon dioxide-containing flow 19a preferably has a higher molar proportion of carbon dioxide than the hydrogen-containing flow 19b. It is also preferred that the hydrogen-containing flow 19b has a higher molar proportion of hydrogen than the carbon dioxide-containing flow 19a. Both the carbon dioxide-containing flow 19a and the hydrogen-containing flow 19b may contain further components.

According to the present exemplary embodiment, the carbon dioxide-containing flow 19a has a mass flow of 305,372 kg/h at a temperature of 40° C. and a pressure of 1.5 bar, and a molar proportion of 99% carbon dioxide. Meanwhile, the hydrogen-containing flow 19b has a mass flow of 14,654 kg/h at a temperature of 45° C. and a pressure of 7 bar. The hydrogen-containing flow 19b also has a molar proportion of substantially 60% carbon dioxide, 1% carbon monoxide, 31% hydrogen, 6% methane and 2% argon.

It is preferred that the hydrogen-containing flow 19b is at least partially and in particular substantially entirely fed to the purge flow 9. This feed preferably takes place upstream of the recovery compressor 12a in terms of the process, as shown in FIGS. 2 and 3. It may also be the case that at least a part of the hydrogen-containing flow 19b is used to underfire one or more heat exchangers or to superheat steam for the operation of one or more compressors of the plant. For this purpose, at least a part of the hydrogen-containing flow 19b may be fed to the exhaust gas flow 14.

It is further preferred that the carbon dioxide-containing flow 19a is sequestered or mineralized. The carbon dioxide-containing flow 19a is therefore fed to storage or mineralization, which shields the carbon dioxide of the carbon dioxide-containing flow 19a from the atmosphere or chemically converts it. It may also be that the carbon dioxide-containing flow 19a—as shown in FIGS. 1 to 3—is fed to a CO2 compressor 26, which increases the pressure of the carbon dioxide-containing flow 19a for sequestration or mineralization and which is preferably a part of the plant.

It is also preferably provided that a part of the synthesis gas flow 6 is branched off downstream of the carbon dioxide scrubber 19 in terms of the process and fed to the purge flow 9. This means that more hydrogen is available for underfiring the heat exchangers or superheating steam to operate the compressors.

It is also preferred that the carbon dioxide is washed out of the synthesis gas flow 6 in multiple stages in the carbon dioxide scrubber 19. This therefore effectively means that the synthesis gas flow 6 is fed to the carbon dioxide scrubber 19 multiple times.

A preferred embodiment is characterized in that the synthesis gas flow 6 is fed to a shift device 22, that the synthesis gas flow 6 fed to the shift device 22 contains water, and that a water gas shift reaction takes place in the shift device 22 to convert at least most of the carbon monoxide in the synthesis gas flow 6 with the water into carbon dioxide and hydrogen. Consequently, at least 50% of the carbon monoxide molecules in the synthesis gas flow 6 are converted into carbon dioxide and hydrogen. It may also be that at least 75% of the carbon monoxide molecules in the synthesis gas flow 6 are converted into carbon dioxide and hydrogen.

The shift device 22 is preferably part of the suggested plant. This feed to the shift device 22 is preferably carried out upstream of the carbon dioxide scrubber 19 in terms of the process, as shown in the figures. It is possible that the water in the synthesis gas flow 6 may already be present to be present in the energy carrier flow 2. On the other hand, it may also be supplied in a saturation state—not shown here—to the synthesis gas flow 6. For ammonia synthesis, other than any nitrogen present only hydrogen from the energy carrier flow 2 is of interest, and therefore the carbon oxides in the synthesis gas flow 6 may advantageously be removed from it as completely as possible before it is fed to the adsorption device 7. Due to the water-gas shift reaction performed in the shift device 22, on the one hand additional valuable hydrogen is obtained, and on the other hand carbon dioxide is obtained at the expense of carbon monoxide. By combining with the carbon dioxide scrubber 19 described earlier, the composition of the carbon oxides in the synthesis gas flow 6 is first shifted in the shift device 22—with the recovery of hydrogen—in favor of the carbon dioxide compared to the carbon monoxide. and then the carbon dioxide is washed out substantially completely. As a result, the synthesis gas flow 6 supplied to the adsorption device 7 only contains a small proportion of carbon oxides, and the load on the adsorption device 7 is therefore low. Besides the shift device 22 and the carbon dioxide scrubber 19 shown in the figures, the synthesis gas flow 6 between the synthesis gas reactor assembly 5 and the adsorption device 7 may pass through further process stages not shown or described separately here, in particular such for changing the temperature or the water or water vapor content.

In the exemplary embodiments, the synthesis gas flow 6 supplied to the shift device 22 has a mass flow of 522,393 kg/h at a temperature of 320° Celsius and a pressure of 71.5 bar. The synthesis gas flow 6 has a molar proportion of substantially 6% carbon dioxide, 16% carbon monoxide, 44% hydrogen, 1% methane, 1% nitrogen and 32% water. The synthesis gas flow 6 obtained from the shift device 22—which has thus already undergone the water gas shift reaction described above—then has a mass flow of 522,397 kg/h at a temperature of 355° C. and a pressure of 69 bar. In terms of its composition, it now has a molar proportion of substantially 21% carbon dioxide, 1% carbon monoxide, 58% hydrogen, 2% methane, 1% nitrogen and 18% water. The hydrogen fraction has thus increased markedly by 14 percentage points and thus more than 25%, whereas the carbon oxides in the synthesis gas flow 6 now consist almost entirely of carbon dioxide.

It is preferred that the synthesis gas reactor assembly 5 obtains the synthesis gas flow 6 from the energy carrier flow 2 by autothermal reforming with the oxygen flow 3, so that a catalytic partial oxidation provides the heat required for the endothermic reforming reactions. This therefore represents the autothermal reforming known from the prior art, which is also referred to as catalytic partial oxidation. Here it is further preferred that the synthesis gas flow 6 exits the synthesis gas reactor assembly 5 with an outlet pressure of at least 50 bar, preferably from 65 bar to 75 bar. In the present exemplary embodiment, the synthesis gas flow 6 exits the synthesis gas reactor assembly 5 at a pressure of 72 bar and a temperature of 1025° C. The synthesis gas flow 6 has a total mass flow of 522,393 kg/h and molar proportions of substantially 6% carbon dioxide, 16% carbon monoxide, 44% hydrogen, 1% methane, 32% water and less than 1% nitrogen respectively. This high outlet pressure is made possible by an original pressure of the energy carrier flow 2 of more than 78 bar and the absence of a need to reduce the pressure for steam reforming, which is not necessary here.

Through this autothermal reforming, it is therefore possible to achieve greater pressures in the synthesis gas flow 6—especially compared to conventional steam reforming—, which allows a lower compressor output upstream of the ammonia reactor assembly 11. Another advantage is that no external energy has to be supplied, so that the process of syngas production does not represent a CO2 burden.

A preferred embodiment is characterized in that the adsorption device 7 includes a plurality of containers with an adsorbent. The containers may be operated alternately in one of several phases. It is therefore preferred that the adsorption device 7 is set up for pressure swing adsorption and that alternatingly the synthesis gas flow 6 is supplied in at least one of the plurality of containers at higher pressure in an adsorption phase to obtain the hydrogen flow 8, and the purge flow 9 discharged from at least one other of the plurality of containers at lower pressure in a rinsing phase. This is the principle of pressure swing adsorption (PSA), which is known from the prior art. In other words, at any one time some of the containers of the adsorption device 7 are operated in the adsorption phase, in which the synthesis gas flow 6 undergoes adsorption, and at the same time other containers of the adsorption device 7 are cleaned of the adsorbed substances in the rinsing phase. By operating the containers of the adsorption device 7 in different, alternating phases, both adsorption and rinsing can be carried out as a whole continuously. There may also be phases other than the adsorption phase and rinsing phase described. It is further preferred that the adsorbent includes a molecular sieve for separating hydrogen. It may also be that the higher pressure of the adsorption phase is achieved by compressing the synthesis gas flow 6 in the adsorption device 7. In the exemplary embodiment shown in FIG. 1, the synthesis gas flow 6—including the recovery flow 13—reaches the adsorption device 7 at a pressure of substantially 65.5 bar and a temperature of 20° C. and for a total mass flow of 105,767 kg/h contains molar proportions of substantially 3% carbon dioxide, 1% carbon monoxide, 91% hydrogen, 4% methane and 1% nitrogen respectively. It is apparent that the proportion of hydrogen is very high even before feeding to the adsorption device 7, which leads to its relief. The hydrogen flow 8 from the adsorption device 7 then has an overall] mass flow of 41,175 kg/h at 43° C. and a pressure of 64.9 bar and consists substantially entirely of hydrogen.

A further preferred embodiment of both the suggested process and the suggested plant is characterized in that the adsorption device 7 is configured for temperature swing adsorption and that alternatingly the synthesis gas flow 6 is supplied in at least one of the plurality of containers at lower temperature in an adsorption phase to obtain the hydrogen flow 8, and the purge flow 9 discharged from at least one other of the plurality of containers at higher temperature in a rinsing phase. This is also the principle of temperature swing adsorption (TSA), which is known in principle from the prior art. This operating mode according to temperature swing adsorption may also be combined with the pressure swing adsorption described above. In such case, it may be that the higher temperature is achieved through an exchange of heat with a warmer fluid and/or the lower temperature is achieved through an exchange of heat with a colder fluid.

A preferred embodiment is characterized in that, in order to obtain the purge flow 9, a nitrogen-containing flushing flow 15, preferably consisting substantially of nitrogen, is fed to the adsorption device 7. Compared to a conventional flushing flow consisting substantially of hydrogen, this has the advantage that the losses of hydrogen due to the flushing process are significantly reduced. Here in particular, it may be that in the flushing phase the flushing flow 15 for flushing out the purge flow 9 is supplied to at least one other of the plurality of containers. While most of the flushing flow 15 used leaves the adsorption device 7 with the purge flow 9, a smaller part remains in the adsorption device 7 after the purging process and leaves it with the hydrogen flow 8. The hydrogen flow 8 therefore contains a small proportion of nitrogen, which however does not interfere with the downstream ammonia reactor assembly 11 and in fact is actually desirable because it reduces the nitrogen flow 10 that is to be added.

Accordingly, with regard to the hydrogen flow 8 it is preferred that it has a molar proportion of at least 90% hydrogen and preferably at least 95% hydrogen. It may also have a molar content of at least 99% hydrogen. It may also be the case that the hydrogen flow 8 consists substantially of hydrogen and the nitrogen remaining in the adsorption device 7 from the flushing flow 15. Alternatively, however, it may also be that the hydrogen flow 8 consists substantially of hydrogen.

In the case of a nitrogen-containing flushing flow 15, the composition of the purge flow 9 corresponds to the flushing flow 15 minus the amount of nitrogen remaining in the hydrogen flow 8 with the substance flushed out of the adsorption device 7, which substance in turn corresponds substantially to the synthesis gas flow 6 minus the hydrogen flow 8.

In principle, the nitrogen in this flushing flow 15 may come from any source. It is preferred that the flushing flow 15 is obtained from an air separation unit 16 for obtaining nitrogen and oxygen from ambient air 16a and fed to the adsorption device 7. The air separation unit preferably has an air compressor 16b for increasing the pressure of the supplied ambient air. This air separation unit 16 is preferably a part of the suggested plant. Such an air separation unit 16 may supply multiple substance flows for the suggested process and the suggested plant. Accordingly, it is further preferred that the nitrogen flow 10 is supplied by the air separation unit 16. In this case, it is preferred that the flushing flow 15 has a lower pressure than the nitrogen flow 10. It is further preferred that the oxygen-producing assembly 4 includes or consists of the air separation unit 16. In this case, the oxygen flow 3 is also supplied by the air separation unit 16.

In principle, the air separation unit 16 may be operated with energy from any source. In order to achieve the desired CO2 balance, the air separation unit 16 is preferably operated with steam obtained in the synthesis gas reactor assembly 5.

According to a preferred embodiment, it may be that the ammonia reactor assembly 11 has a reactor stage 11a for the ammonia synthesis and a condensation stage 24 arranged downstream in terms of the process of the reactor stage 11a for separating ammonia 1 from residual gas 24a. Then the ammonia 1 synthesized in the reactor stage 11 is first passed out of the reactor stage 11a as a raw ammonia flow 23 and fed to the condensation stage 24, from which the ammonia 1 is obtained by condensation. A remaining residual gas 24a is recycled from the condensation stage 24 to the reactor stage 11a after the pressure has been increased by a residual gas compressor 24b of the ammonia reactor assembly 11. Here, it is further preferred that cooling of the condensation stage 24 is coupled with the carbon dioxide scrubber 19 for cooling the scrubbing medium in a manner not shown in FIG. 1.

Preferred embodiments of the suggested process described above correspond to preferred embodiments of the suggested plant and vice versa.

1-16. (canceled)

17: A method for producing ammonia, the method comprising:
providing an oxygen flow from an oxygen producing assembly;
providing a carbon-containing energy carrier flow;
feeding the carbon-containing energy carrier flow and the oxygen flow to a synthesis gas reactor assembly to obtain a synthesis gas flow comprising hydrogen and carbon oxides;
feeding at least a part of the synthesis gas flow to an adsorption device which separates the synthesis gas flow into a hydrogen flow comprising hydrogen and into a purge flow comprising carbon oxides;
providing a nitrogen flow;
feeding at least a part of the hydrogen flow and the nitrogen flow to an ammonia reactor assembly which converts the part of the hydrogen flow and the nitrogen flow into ammonia; and
feeding at least some of the carbon oxides in the purge flow to the synthesis gas reactor assembly.

18: The method as recited in claim 17, further comprising:
obtaining a recovery flow and an exhaust gas flow from the purge flow; and
feeding at least a part of the exhaust gas flow to the synthesis gas reactor assembly.

19: The method as recited in claim 18, wherein,
the recovery flow comprises hydrogen, and
the exhaust gas flow comprises carbon oxides; and
the method further comprises:
using the recovery flow to underfire a heat exchanger.

20: The method as recited in claim 18, further comprising:
splitting the purge flow into a first partial purge flow and a second partial purge flow,
wherein,
the first partial purge flow forms the recovery flow, and
the second partial purge flow forms the exhaust gas flow.

21: The method as recited in claim 18, further comprising:
feeding the purge flow to a recovery assembly which is configured to recover the recovery flow and the exhaust gas flow from the purge flow.

22: The method as recited in claim 21, wherein,
the recovery flow has a higher molar proportion of hydrogen than the exhaust gas flow, and
the exhaust gas flow has a higher molar proportion of carbon oxides than the recovery flow.

23: The method as recited in claim 21, wherein the recovery assembly comprises a membrane device which is configured to separate hydrogen out of the purge flow.

24: The method as recited in claim 23, wherein,
the membrane device is further configured to separate the recovery flow from the purge flow so that only the exhaust gas flow remains, and
the method further comprises:
using a part of the exhaust gas flow as a membrane flushing flow in the membrane device for flushing out the recovery flow.

25: The method as recited in 21, wherein the recovery assembly includes a recovery adsorption device which is configured to separate hydrogen out of the purge flow.

26: The method as recited in 25, wherein the recovery adsorption device is further configured to separate the recovery flow from the purge flow so that only the exhaust gas flow remains.

27: The method as recited in claim 25, wherein the recovery adsorption device is further configured to provide at least one of a pressure swing adsorption and a temperature swing adsorption.

28: The method as recited in claim 25, wherein the recovery assembly includes a recovery compressor which is configured to increase a pressure of the purge flow.

29: The method as recited in claim 28, wherein the recovery compressor is further configured to increase the pressure of the purge flow before the purge flow is supplied to the recovery adsorption device or before the purge flow is supplied to the membrane device.

30: The method as recited in claim 17, further comprising:
using at least a part of the hydrogen flow to underfire a heat exchanger.

31: The method as recited in claim 17, further comprising:
feeding a part of the synthesis gas flow to a carbon dioxide scrubber which is configured to wash at least a part of the carbon dioxide out of the synthesis gas flow.

32: The method as recited in claim 31, wherein the washing out of the at least a part of the carbon dioxide from the synthesis gas flow is performed by the carbon dioxide scrubber in a plurality of stages.

33: The method as recited in claim 31, wherein the carbon dioxide is washed out in the carbon dioxide scrubber using a scrubbing medium comprising methanol.

34: The method as recited in claim 31, wherein the carbon dioxide scrubber washes out the at least a part of the carbon dioxide out of the synthesis gas flow by discharging a carbon dioxide-containing flow and a hydrogen-containing flow.

35: The method as recited in claim 31, further comprising:
feeding at least a part of the hydrogen-containing flow to the purge flow.

36: The method as recited in claim 31, further comprising:
branching off a part of the synthesis gas flow downstream of the carbon dioxide scrubber; and
feeding the branched off part of the synthesis gas flow to the purge flow.

37: The method as recited in claim 31, wherein,
the synthesis gas flow further comprises water and the carbon oxides in the synthesis gas flow include carbon monoxide, and
the process further comprises:
feeding the synthesis gas flow to a shift device which is configured to have a water-gas shift reaction take place therein so as to convert a substantial part of the carbon monoxide with the water into carbon dioxide and hydrogen.

38: The method as recited in claim 37, wherein the synthesis gas flow is fed to the shift device upstream of the carbon dioxide scrubber.

39: The method as recited in claim 17, wherein,
the synthesis gas reactor assembly obtains the synthesis gas flow from the carbon-containing energy carrier flow via an autothermal reforming with the oxygen flow so that a catalytic partial oxidation provides heat which is required for endothermic reforming reactions.

40: The method as recited in claim 39, wherein the synthesis gas flow exits the synthesis gas reactor assembly with an outlet pressure of at least 50 bar.

41: A plant for producing ammonia, the plant comprising:
an oxygen-producing assembly which is configured to provide an oxygen flow;
a synthesis gas reactor assembly which is configured to obtain a synthesis gas flow comprising hydrogen and carbon oxides from a carbon-containing energy carrier flow and the oxygen flow;
an adsorption device which is configured to separate at least a part of the synthesis gas flow into a hydrogen flow comprising hydrogen and a purge flow comprising carbon oxides; and
an ammonia reactor assembly which is configured to convert at least a part of the hydrogen flow and a nitrogen flow into ammonia,
wherein,
at least a part of the carbon oxides in the purge flow is fed to the synthesis gas reactor assembly.
